(19) United States
(12) Patent Application Publication
(10) Pub. No.: US 2019/0228433 A1
(43) Pub. Date: Jul. 25, 2019

(54) User Generated Mobile Advertisements Creation, Reaction and Distribution Method

(71) Applicant: William Herling, Gig Harbor, WA (US)

(72) Inventor: William Herling, Gig Harbor, WA (US)

(21) Appl. No.: 15/877,385

(22) Filed: Jan. 22, 2018

(51) Int. Cl. G06Q 30/02

(52) U.S. Cl. CPC G06Q 30/0242; G06Q 30/0267; G06Q 30/0276

(57) ABSTRACT

With the increase in consumption of content on a mobile device, in combination with the advent of higher quality camera capabilities of mobile phones, opens a new space for advertisements generated by viewers. User generated advertisements, enable a way for end users seeing advertisements to respond to advertising content by creating and engaging with other end users. Accompanying this is a floating backend system the permits instant connectivity across platforms and applications simultaneously. The floating backend system accesses different platforms simultaneously via aggregators localized and embedded on platforms. These aggregators moderate content offer rewards, geofilters, tagging communication and other Incentives to users.

### CROSS-REFERENCE TO RELATED APPLICATIONS

Ticket number: 1-501571784

Application No. 62/448,792

Submitted: Jan. 20, 2017

U.S. Pat. No. 7,778,872B2 Aug. 17, 2010 Methods and apparatus for ordering advertisements based on performance information and price information

U.S. Pat. No. 7,523,087B1 Apr. 21, 2009 Determining and/or designating better ad information such as ad landing pages

US20100145762A1 Jun. 10, 2010 Publisher ad review

US20060020523A1 Jan. 1, 2006 Method and system for organizing and disseminating information on products featured in entertainment productions

US20040215509A1 Oct. 28, 2004 Method of distributing targeted internet advertisements

US20020046099A1 Apr. 18, 2002 Method for providing customized user interface and targeted marketing forum

US20090299837A1 Dec. 3, 2009 System and method for brand affinity content distribution and optimization

US20110208575A1 Aug. 25, 2011 System and method for generating interactive advertisements

US20070043617A1 Feb. 22, 2007 Multi-site message sharing

US20110307331A1 Dec. 15, 2011 Monitoring clickstream behavior of viewers of online advertisements and search

US20070294401A1 Dec. 20, 2007 Providing collected profiles to media properties having specified interests

US20090198607A1 Aug. 6, 2009 Online map advertising

US20050144069A1 Jun. 30, 2005 Method and system for providing targeted graphical advertisements

US20070067215A1 Mar. 22, 2007 Flexible advertising system which allows advertisers with different value propositions to express such value propositions to the advertising system

US20020194215A1 Dec. 19, 2002 Advertising application services system and method

US20100262456A1 Oct. 14, 2010 System and Method for Deep Targeting Advertisement Based on Social Behaviors

US20070100688A1 May 3, 2007 Method and apparatus for dynamic ad creation

US20060224447A1 Oct. 5, 2006 Automated offer management using audience segment information

US20080320512A1 Dec. 25, 2008 Systems and methods for providing interactive advertisements through media player

US20110055008A1 Mar. 3, 2011 Method and system for electronic advertising

US20080294523A1 Nov. 27, 2008 Methods and apparatus for advertising via computer networks and websites

US20040215515A1 Oct. 28, 2004 Method of distributing targeted Internet advertisements based on search terms

US20120059713A1 Mar. 8, 2012 Matching Advertisers and Users Based on Their Respective Intents

US20110066497A1 Mar. 17, 2011 Personalized advertising and recommendation

### BACKGROUND OF THE INVENTION

Advertising is adapting to an increasingly digital and mobile world, with billions of people across the world owning a mobile device or tablet. With the new surge in mobile device usership, a relative increase in mobile advertising is taking place, offering a new opportunity in the methods and means to change the way people engage with and create advertising content.

Mobile advertisements today are often introduced in the form of banner, video, image, and pop-up methods that collectively dominate the form of advertisement presentation in the mobile and digital advertising space. These mobile advertisements are often introduced in an annoying or counterproductive fashion, with the timing,form, and presentation of these ads creating a poor experience that disengage mobile users. Studies show the greater number of ads an individual sees, in a set period of time, the more annoyed they become, and thus have a negative view of the advertisement or company deploying the advertisement. Yet there is a ripple effect, as this negative perception from users has an impact on not only advertisers but equally app developers, site hosts, and original content creators—or those who host the portal where the advertisement was originally presented. This poor presentation of advertisements ultimately detracts from the original and intended purpose of the user, as it diminishes their overall experience on the site, mobile application or other portal from where the content was introduced, consequently resulting in a negative perception of both the company or brand that created the advertisement in addition to the site, application or source of where the advertisement was presented.

Advertisement relevancy is an equally important part of the mobile experience. Poor advertisement presentations have been made worse due to bad reliability, accuracy, and relevancy in the advertisements that are distributed to mobile users. In many cases, advertisements presented to users have little to no relevance. As a result, mobile users become even more frustrated with the mobile advertising experience as content is often not relevant to the user. New methods have been able to improve targeting of users with data to help improve this relevancy, yet ultimately these methods continue to struggle.

Advertisements on mobile, web, and tablets have become so poorly executed that people use services such as Ad Blockers, that specifically prevent advertisements from appearing at all. By blocking an advertiser's content, a user seeks to significantly improve their overall experience with a site, application or platform source by avoiding the annoying presentation, format, or any other factor associated with mobile advertisements altogether. This, however, leaves a significantly worse result for content creators, mobile developers or site hosts, who simply are left unpaid from advertisers, as users intentionally block that advertisers content. As a result, content creators have begun blocking content for people that use Ad Blockers, stating that until a user allows advertisements to be presented, their created content will be unavailable. For example, a newspaper may have an interesting digital article that a person using an Ad Blocker finds appealing. The article or content the newspaper created, in which the person finds interesting, will be blocked until advertisements are allowed to reappear on the person's mobile device, site or application. People may find this process additionally frustrating, cumbersome or irritating.

Ultimately, the current process results in a poor experience for all parties involved: the content host, the advertiser and the user.

Most important, current advertising methods have created restrictions on who can create mobile advertisements. Mobile advertising channels are dominated by large companies and brands, with more resources, connections, influence and monetary considerations who can afford to create and distribute mobile advertising content. These larger companies or brands have connections to advertising agencies who assist in the creation and distribution of mobile advertisements. The advertising agency will often create the mobile content and distribute it through the use of advertising networks. These networks often disenfranchise app developers or site hosts with low fill rates that ultimately reduce the number of advertisements that could be presented to a user. This results in a decrease in the amount of potential income to the application developer or site host. Fill rates are important in advertising because they represent the number of potential advertisements a user could see before being turned off. Therefore, higher fill rates are more beneficial to application developers or site hosts because it offers the potential for more revenue. Current advertisement networks often have low fill rates or instead fill space with irrelevant advertisements to the the user or reuse advertisements previously shown to a user. These advertising networks ultimately contribute to a worse overall experience for both the user and notably the application developer or site host.

This current system and process has become increasingly competitive and has consequently left out a significant number of other business, brands and other potential advertisers. As a result, small businesses, smaller brands, realtors, event planners, bakers, shopkeepers, community organizers, and many other groups, who have fewer resources and considerations, have become increasingly marginalized in this process of the development of mobile advertisements. Restrictions on the access of the creation and distribution methods in mobile advertisements have limited both the number of advertisements and especially the quality of advertisements that are created. These limits for smaller and localized advertisers, have significantly reduced the scope of application of mobile advertising, leaning heavily on larger companies with greater resources, leaving absent smaller and leaner brands or businesses.

Meanwhile, new mobile devices have significantly improved audio and camera capture processes, as people today capture billions of photos and videos on mobile devices, from selfie images to panoramas, raw videos to artistic photos, and everything in between. Content that is captured today continues to improve in quality as the technology to capture images, videos, audio and other forms of content improve. These better capture technologies on mobile devices have enabled new and improved ways that have increased the simplicity, reliability, and ease of image, video and audio capture. This has resulted in an increase in the variety of people who can capture content anywhere, opening a new wave of constant content creation through mobile devices. Through the improvement of capture technologies on mobile devices, people around the world have become enabled to create and distribute content immediately, no longer facing barriers of traditional image, video, or audio content capture. The end result, is more content being captured, created, or shared than ever before.

### BRIEF SUMMARY OF INVENTION

With the advent of mobile devices and, with it, significantly improved camera technology, especially in the quality and ease of image or content capture, the number of people capable of capturing high quality image and audio mobile content is surging. Social media platforms, which in large part, focus extensively on encouraging the creation and sharing of content generated by end users, or those individuals or entities that make up the ‘user base’ of the platform. At the same time, an increase in mobile content consumption, has increased a desire for businesses, individuals, and other entities to advertise ideas, products, services and movements to reach this increasingly attractive market. Yet, current advertising methods are cumbersome, outdated, and often counterproductive as they are aggravating, irritating, and bothersome to the end user. For a number of reasons, including the relevance of the ads, the loud or explosive nature in the design of the ads, and the nature in which they are presented (often untailored to a mobile experience), create this troubling experience for both the advertiser (in unsatisfied customers) and end user (in poor experience). Out of this, comes an opportunity for user generated advertisements. A user generated advertisement is ad content that is created by an end user, viewer or individual not related to the original designee or initiator of the advertisement (i.e. the business or entity running an ad campaign), in response to an advertisement. In this way, user generated advertisements are more natural to the platforms the originate from and create a more authentic lens on the scope of advertisement itself, not one that originates in a lab or advertising agency.

User generated advertisements (“UGAds”) are prompted by another viewer or traditional stimulus (primer ad). An end user then ‘reacts’ to this initial stimulus (or primer advertisement) within the advertisement itself, by creating content of their own which may vary in form—from images, video, audio, filters, games or any other desired medium. User generated advertisements simultaneously connect individuals on other devices and other platforms concurrently, able to create and share borderless content in near real time. In this way, through a floating backend system and localized aggregators, content can be filtered and shared to other devices on the same platform and or on other platforms. For example, a user generated advertisement created on Platform A may be shared to Platform B, and vice versa. This is made possible through the floating back end system and its communication with aggregators, in parallel campaign distribution. Aggregators are locally hosted sources, initiated or implemented by the platform host, via the code base. Once content is created on a platform, it is shared with the local aggregator of that platform. If determined to share publicly, it will be sent to the floating back end system, which will then process the shared content and search for other aggregators to share it with, via a tagging and moderation system. Once sent to the identified localized aggregators via the floating backend system, the content is then publicly shared on the targeted platforms. Through this way, content can be created and shared on multiple platforms on multiple devices, simultaneously. A tagging and moderation system within each aggregator, enables more targeted, accurate, and safe content to flow from user to user.

Also comprised, is a way to ‘gamify’ or create reward based elements for user generated advertisements. A universal reward system is initiated across devices and platforms through authentication tracking via the aggregator and floating backend system. By way of example, a user on Platform A may earn rewards that can be used on Platform B, authenticated through standard device protocols, such as passwords, thumb prints, facial recognition and any other authentication tools. These rewards, once authenticated or identified, may be triggered by specific calls to action, designated by the local aggregators, such as an interaction of some kind (e.g. capturing an image or sharing it). Additionally, localization may trigger certain rewards or incentives, utilized via the tagging in the communication between the aggregator and the floating back end system. Likewise, through the authentication tracking, an embeddable purchase function enables a user to purchase, save or engage with an item (such as a ‘favorite’ or ‘like’ action) within the advertisement itself. By keeping this within the advertisement, an end user avoids the current process of opening a new window or application and then leaving the current platform and its content altogether. Through these methods, user generated advertisements offer a better way to engage, create, and connect with content meant to serve the purpose of an advertiser through a more engaged, targeted, and localized way.

### BRIEF DESCRIPTION OF DRAWINGS

FIG. 1 illustrates the Reaction and Distribution method of a user generated advertising. At numeral 100, a user views an advertisement either created by another user or by a larger brand, and at numeral 110, ‘reacts’ to the content, through an interaction or gesture. By reacting, a user may create content or recall content that was previously captured, e.g. image based content captured by a camera. If a user creates image based content, a live, fully embeddable camera is called and a user may capture and preview content. At numeral 130, a user may decide to share content either privately (only to themselves) or publicly (sharing to others). Once a user decides to share content publicly or privately, the content is uploaded to the aggregator, noted at numeral 140, which then supplies and stores that content in a floating backend system, numeral 145. Content being stored within the floating backend system may be shared to other aggregators at that point based on the parameters and input of a user, shared through the aggregator. Once content is publicly shared, content may be distributed using the floating backend system and through other aggregators, able to distribute to other applications, noted in numeral 150. That content shared together, then appears on the original and or other applications or platforms the content was designated to be shared with (via the parameters in the aggregator). Users on the original or other platforms may now react to or engage with this new content at numeral 170, creating a loop of users seeing, creating, and reacting to new content within the same or other applications. Additionally, at numeral 120 rewards or other forms of content may issued to users.

FIG. 2 demonstrates the embeddable response and reaction method. After seeing an advertisement or other content, a user may respond through actions that are fully embeddable within the application, site or portal by which they are engaging. By reacting,designated at numeral 210, a user may create content in two distinct manners. First, at numeral 220, a user may select and upload content previously captured by opening a gallery embedded within the mobile device itself or through a third party application. Or second, at numeral 230, by opening a live, fully embeddable camera within the application, site or portal. This operation of the camera may capture video, image, audio, interactive images or other forms of mobile content capture and includes filters or other forms of entertainment that may be distributed through an aggregator and its parameters. Content is created at numeral 240, and uploaded to the aggregator and floating backend system, designated by numeral 250. The content is then distributed to other localized aggregators via the floating backend system at numeral 260.

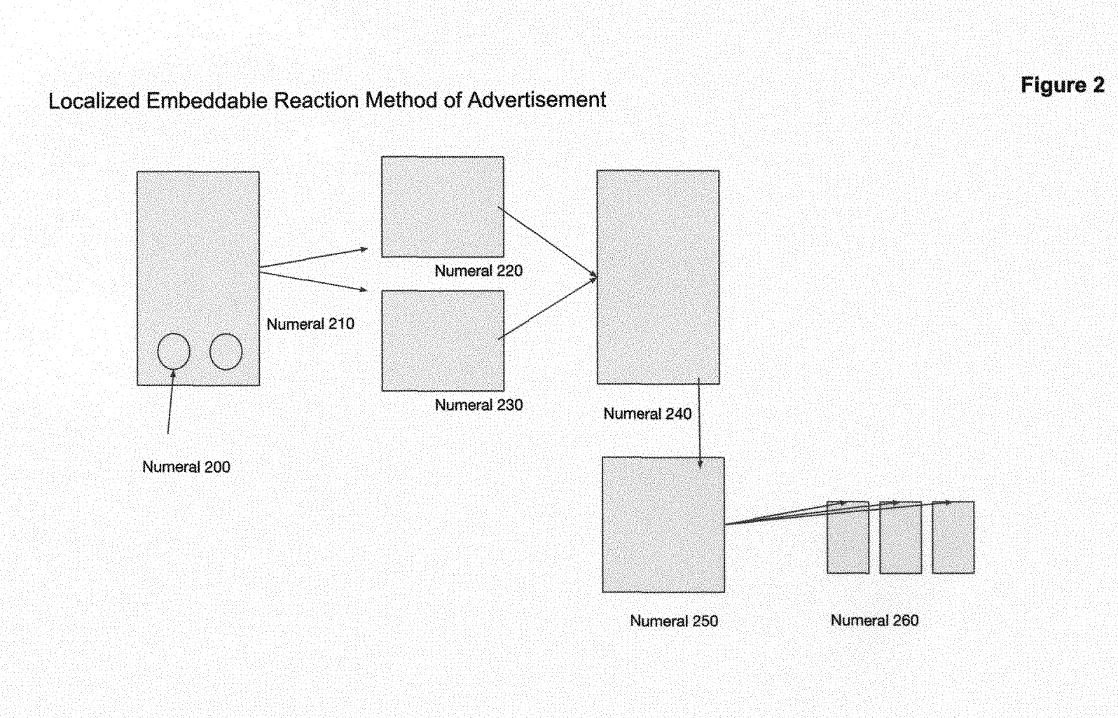

FIG. 3 shows content created on a third party application or platform uploading separately to an aggregator and processing through the floating backend system to then distribute the content that was created and shared. Numeral 300 represents the separate application or platform where content was created or uploaded. Numeral 310 and 320 illustrates the uploading of content to the localized aggregator and floating backend system, with content then processed through parameters within the aggregator at numeral 330, before finally appearing on other applications or portals at numeral 340.

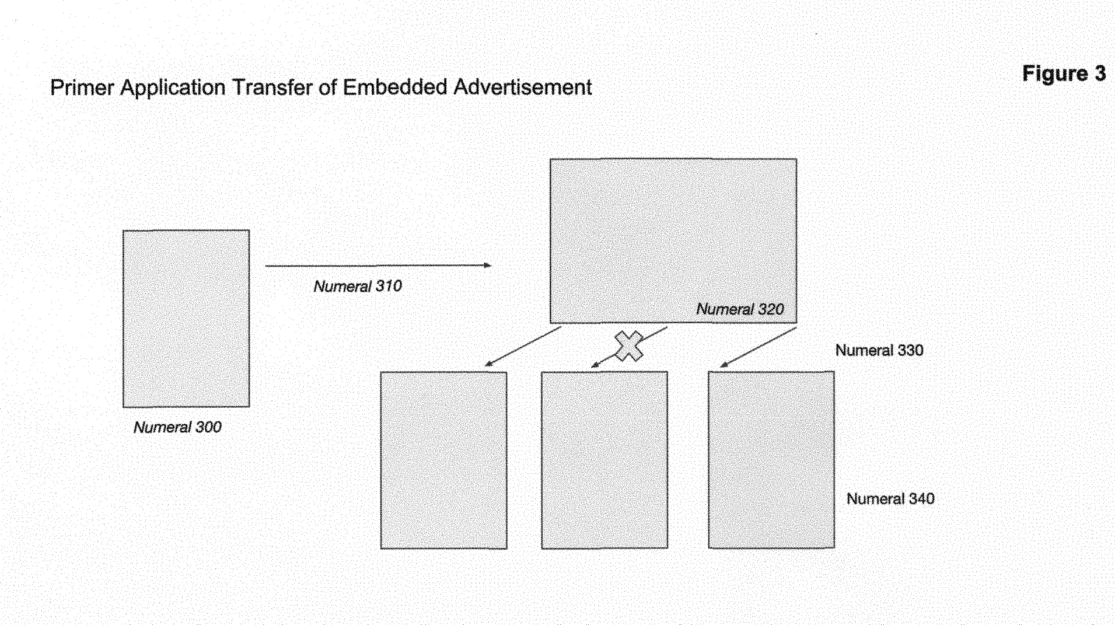

FIG. 4 depicts the process of combining content created and shared at different access points and processing to together to a joint aggregator and backend system. Content that was created within an application or a separate application, noted by separate numerals 400 and 410, may still uploaded to the same aggregator and then presented to users together. The uploading and combination of such content will fully adhere to parameters inputted at the aggregator, numeral 420, before finally being shared to other users at numeral 430.

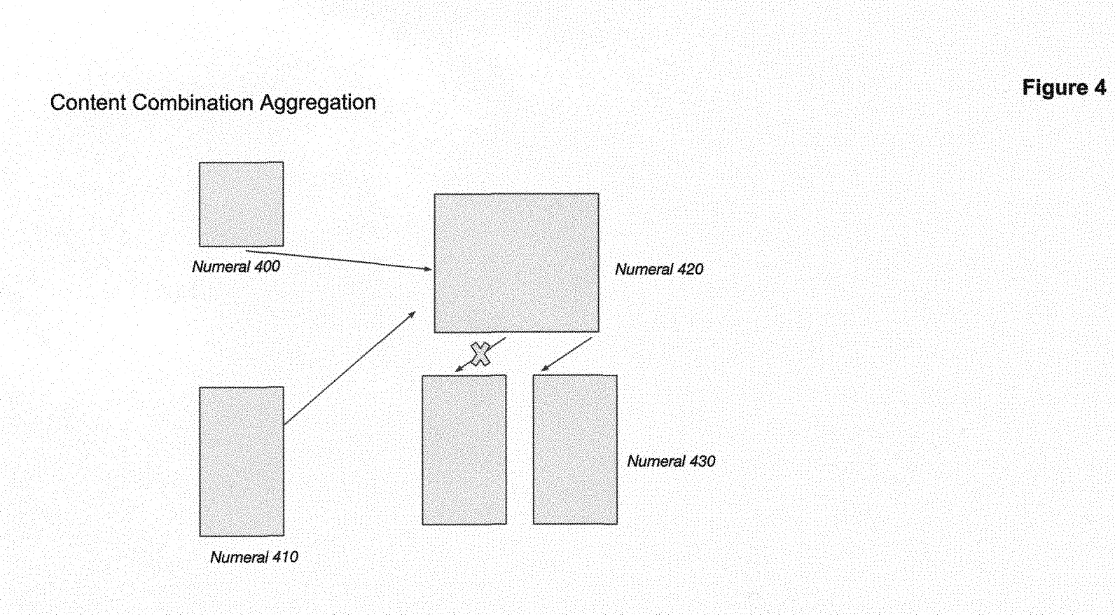

FIG. 5 represents the parallel ad campaign where multiple users may be sharing or communicating with each other at the same interval. At numeral 500, separate users, either on the same application or on a separate application or a third party platform, may be creating live content to be shared to the floating backend system and aggregator, noted at numerals 510 and 520. Where the content is moderated and shared through each individual aggregators on other platforms and then shared with their users, at numeral 530. Users may then react to that content and live and communicate with other individuals on separate applications all at the same interval, live. Between numerals 530 and 540, the users are essentially reacting to each other or are able to communicate live.

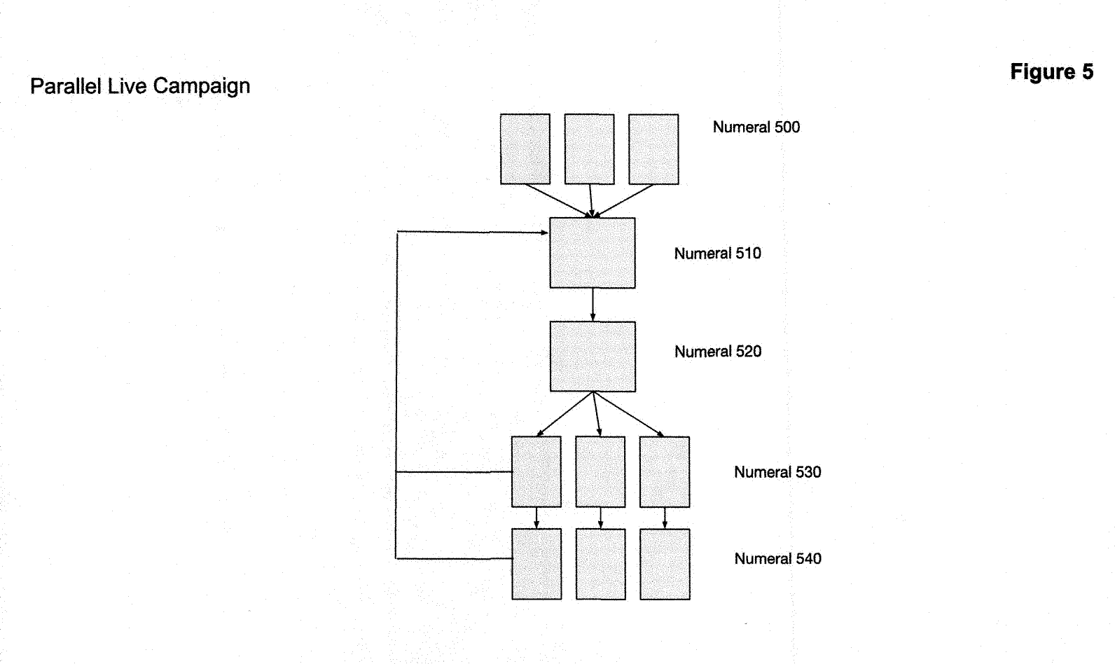

FIG. 6 portrays the user contribution and implementation method, demonstrating how content created or uploaded by a user organized and presented to other users. As an individual user creates content at numeral 170, either through an embeddable display or through a third party site, the content created is uploaded to the aggregator and floating backend system at numeral 610. From this point, the content is distributed through the aggregator and displayed within the application or site, presented and organized in a manner aligned with the input of the aggregator, represented by numeral 620. New content that is created within the application or site at numeral 630, either through the reaction or upload method described herein, is then displayed in a method designated by the aggregator. For example, the newest content created may be presented first.

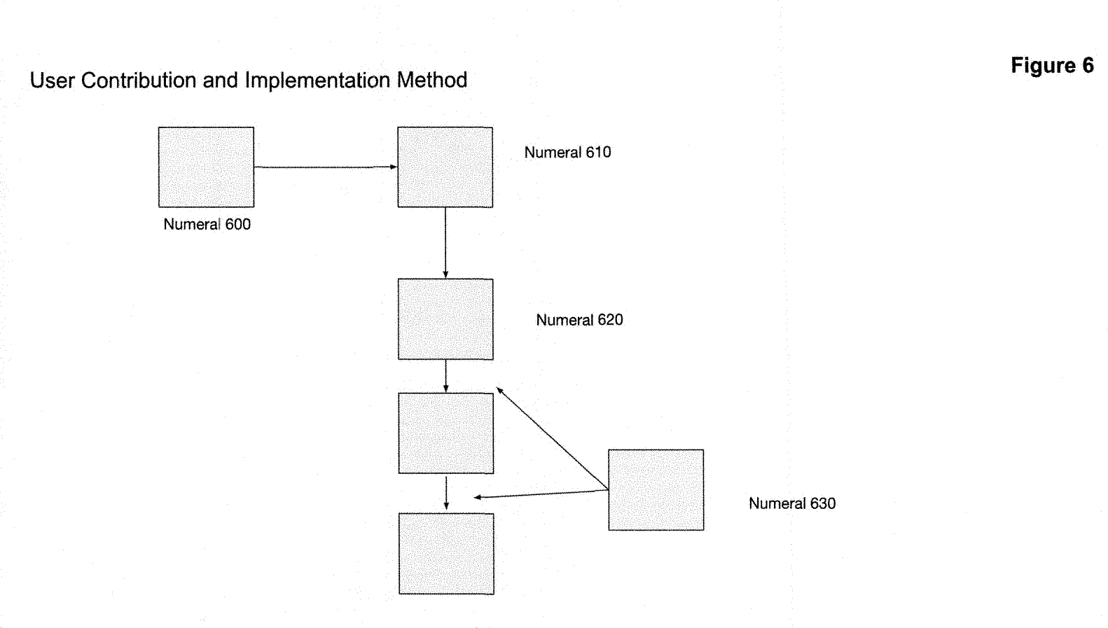

FIG. 7 illustrates the floating backend system storage, aggregation, and distribution process. Content that is created within an application is sent through the aggregator associated with that application or site, at numeral 710 and is stored until called to share the content. Once shared it is routed through the original designated aggregator at numeral 710 and distributed to users within the application meeting parameters. Then content, if selected to share, is selectively distributed to other aggregators throughout the practice of the floating backend system, noted as numeral 730. This ‘floating’ backend system moves content to aggregators that align with the original parameters of the aggregator where the content being distributed originated, at numeral 740. Numeral 730 represents that multiple floating backend systems may be providing content to the same aggregator, as denoted in this depiction. Content from the aggregators at numeral 740 are then distributed to users or other platforms at numeral 750.

FIG. 8 shows the recall and presentation of content. At numerals 800 content is created and at numeral 810 distributed to an aggregator and floating backend system. Content is then presented at numeral 820, based on the inputs designated at numeral 810 of the aggregator, to an end user. To see more content or engage with content further, the user engages with numeral 830 to call additional content. This content may be created by any user through any access point, through other embeddable reactions or through a third party application. A user may see full screen, fully embeddable images, in the form and organization of a ‘feed’ displayed to the end user, denoted by numerals 840 and 850. At any point, the user may engage with previously viewed content or call new content, all based on the interactions of the user. At any point a user may leave the content and return to the original programing or content of the site or source of the platform.

FIG. 9 illustrates an embeddable purchase display and tagging method. In this way, content that is created by a user may have aspects or areas of the photograph, video, or other forms of content specifically tagged or marked with a link (or interaction method) to purchase some service or content that is being advertised. Through the described, users can choose to purchase products or services within ads, without leaving screens or sessions to outbound to other links. When an image is processed through an aggregator it may be tagged by an advertiser, site host, or in some cases end user. Once the content is tagged it is packaged together and distributed following normal procedures of the creation and distribution method described. Once a user engages with the tag, denoted by numeral 940, a purchase and payment method is called at numeral 950 using the floating backend system and payment processing of both the tagged content and of the user, denoted at numeral 970. A user may also ‘save’ or store the item for later not necessary to purchase, this occurs at numeral 960 as well. Once complete, the user may return to their original content.

### DETAILED DESCRIPTION OF THE INVENTION:

Combining these elements, opens a new opportunity to utilize the improved technological capabilities of video, image, and audio capture methods to make use of user generated content in the space of mobile advertisements. The benefit of user generated content in mobile advertising is significant. By opening content creation to any person or business, more content could be created, and thus could have greater relevance to mobile users, greater engagement for advertisers, better interconnectivity for application developers or site hosts, and an improved overall experience for end-users. Potentially, greater user engagement could follow, as an increase in user created content would lead to more relevant content available, in addition the engagement of users directly creating content to be used as an advertisement. With greater advances in technology, more people are enabled to create and capture content, therefore helping to improve the relevancy, reliability, and accuracy in the presentation, form and delivery of mobile advertisements.

Today, current methods are lacking in mobile advertising to create, distribute or contribute in a mobile advertisers campaign through the content creation of an advertisement itself. On social media platforms, marketing campaigns often will use current social networking services, that utilize components like hashtags or other forms of user content, to engage with and connect with mobile or desktop users. But limited in these services, is the ability to form advertisements fully created by end mobile users. As noted earlier, complicated advertisement creation tools, in addition to a competitive bidding process and restrictions on monetary considerations or resources, completely strangle the access of content creation.

With this process, the creation of advertisements is fully democratized, in the hands of everyday people including small brands or businesses. This process combines elements of advertising and user generated content to create more relevant, meaningful, and engaging advertising content to be used on mobile devices, mobile sites, mobile applications and other other areas where content can be consumed.

Described herein is a method of incentivizing user created content, to be distributed through a floating backend system that utilizes a unique aggregator that is embedded within a mobile application, site or portal, that is presented in the form of an advertisement. User generated advertisements are first created by a user and may be distributed throughout multiple applications, websites or portals. By using the improved capture technologies of smartphones or tablets, a mobile user generates content either by capturing an image, video, and/or audio live or by retrieving archived content previously captured. The content is then uploaded to an aggregator, which uses the floating backend system, as it then distributes content to other mobile applications, sites or portals based on parameters inputted by the original assignee of the advertisement (the brand or business paying for the advertisement or series of advertisements to be displayed) and the portal host (the mobile application, website or portal where the content is displayed to the user). The advertisement is then routed through a floating backend system which keeps all content generated by both users and advertisers embedded within the application or site that is displaying the advertisement. The floating backend system is described in further detail below. Alternatively, content can be distributed and hosted on separate third party backend or hosted within the aggregator itself, depending on storage needs and other considerations.

Once content is created it follows the floating backend system guidelines (described below in ‘Floating Backend System’) and transferred through the aggregator, the advertisement content then appears within the selectively distributed applications, sites, or portals, based upon the parameters inputted by both the advertiser initiating the advertisement and the portal displaying the advertisement. These parameters often include the timing of an advertisement presented to a mobile user—for example an action (like an article is selected) or after a certain period of time (x number of seconds on an application) an advertisement would appear. Parameters of the aggregator that will also impact the distribution of content are factors such as keywords. Keywords are set by the site hosts, application developers or managers, and other portal facilitators. Keywords act to better target users with relevant advertisement content. The aggregator takes keywords and other specified data inputted by application, site or portal hosts and matches the information with keywords and terms inputted by advertisers or brands. By matching inputted terms, such as keywords, with both the site host and with the brand, advertisements are better targeted in relevance to the end mobile user. Localized information, through the use of mapping, may be also used to utilize user data tracking or other forms of localization may be used to generate relevant advertisement content. The use of keywords in addition to localization, helps to better generate content relevant for every mobile user. For example, a running application may use the keywords “fitness” or “running shoes” as well as a location specific for some users, to help define parameters for their application. A local running shoe store, would also use these terms in hoping to procure a buyer for their shoes in a certain location. Using both the keywords and the location data, the aggregator better matches advertisements to applications. When unable to procure relevant terms or produce significant matching results, other resources may be used to generate and present relevant advertising content to the user.

After the creation, transfer and distribution process, an advertisement appears in an application, website or other portal that has been designated for an advertisers content to be displayed. This is made possible through the use of a wrapper, such as an embeddable code snippet or application plugin, installed by the mobile application, website, or portal—often by the developer or host of that portal.

These hosts can often be a group of people or a single individual. Once the wrapper or snippet of code is embedded within the application, site or portal, the unique aggregator and floating backend system are then activated to distribute mobile content from within the application itself or through a separate application, adhering to matching tags. Additionally, the content created within the application may be shared inside the same application it was created or may be shared throughout multiple application sites, portals or other third party services, such as social networks or messaging platforms.

The wrapper, or code, may be embedded within the application, site or portal in two ways. First, the code snippet may be installed as a blanket aggregator, meaning a single usage of the snippet will allow for advertisements to be created within the application and shared amongst itself or shared with other applications or third party services. Second, the code may be installed at multiple junctions based on the preferences of the host of the application, site or portal. For example, a host may not want advertisements on certain pages or after certain actions, and therefore, may want a more tailored approach to the display of their advertisements. Additionally the blanket aggregator offers a way for advertisements to be displayed based on tracking user behavior that offers insight into tailoring the presentation of ads uniquely to each individual user. This process utilizes the floating backend system which may track the behavior of users, including location, demographics, specific user interactions, behavioral time and other factors across multiple channels and platforms that help to contribute to better relevancy in the mobile advertising experience. The aggregator utilizes these input values, in addition to other parameters inputted by the brand or advertiser and content host. Once the wrapper or code snippet is installed and embedded the aggregator is activated and may distribute advertisements to and from the application by which the user is engaging with. Content that is created and shared by a user of the mobile application, site, or portal may leave or remain within the original location by which the content was created. Once presented to the user within the application, site or portal the advertisement is fully interactive and operates as fully embeddable within the site or application.

The content can be replicated or transferred to other applications or sites as well, immediately, intermittently or at any combination. This combination of content allows for content generated by users to be mixed with content created by advertisers and then distributed together. This may allow for an advertiser's campaign to better focused on highlighting the content generated by a user. An advertiser may utilize any combination of the content created within the application or from other channels such other platforms, to then distribute content in any way, combination, or timeframe they desire, all based on selective variables inputted to the aggregator.

There may be multiple applications by which an advertiser is running the same advertisement. This creates an opportunity for an advertiser to run the same campaign live across multiple different platforms and mediums. An individual on one application can see the same content at the same time as an individual on a separate application or as another individual does on a separate website. Therefore, each individual regardless of their location, or what medium they are accessing, or what time the individuals are seeing the advertisers content, all individuals are seeing the same content at the same time. This is made possible through the floating backend system and aggregator together embedded within each application, site, or portal. By installing the aggregator, each participating application, site or portal has access to the same content generated or shared live, all at the same time. For example, if content is created on Application A and shared through the aggregator it is visible live on Application B, even though the content was not created on Application B. This example assumes all inputted parameters by the brand or business and the application host are similar. This allows users among other applications, sites, or portals, to generate content and share it together, essentially allowing people to create content on one application or portal and see that same content on another portal. It also offers an opportunity for individuals on these separate platforms or services to communicate and connect with each other.

Additionally, what is unique is the creation process of the advertisement through a mobile application itself. The creation process may use a separate mobile application or within the embedded application itself to capture content live or upload previously captured or shared content. The application's content is instantly sent to a floating backend processing system and then via the aggregator, described above. The mobile application uses significant security and authentication protocols to ensure veracity in the content creators. The individual creating the mobile content may use a separate application or may create content within the application, site or portal where content was presented to them. A user has access to the code base via the aggregator, and thus can contribute content within the application. The application or aggregator also has access to the code base of any other participatory mobile application, site or portal, giving it the ability to generate content within the application or distributed to other platforms via the aggregator. Therefore, users creating content on one application have access to sharing content in the code base via the aggregator of a separate application using the same aggregator. Ultimately, this allows a user to create content on one application, site, or portal and then transfer and/or distribute it to another.

These advertisements described are considered ‘primer’ advertisements or an advertisement created by a party, brand or business to appear within a mobile application or site. The purpose of a primer advertisement is to offer an initial advertisement by which users react or contribute content to. This “reaction” process is described below.

Combining elements of advertising and user generated content, is a response or reaction system that enables user generated content to be created within an embedded system as a ‘response’ or ‘reaction’ to content of an advertiser or user and the primer content. For example, a user will see an advertisement displayed within a mobile application, a mobile website, or platform. The user is then prompted to ‘react’ to that advertisement. Reacting is defined as a way for a user to respond directly to content presented to them, engaging with the content by contributing content to it. By reacting, for example capturing a photograph, a user creates content to be displayed within the set parameters as an advertisement. This content created by a user may be then used for the purposes of an advertisement, distributed at the discretion of the user and advertiser through the parameters of the aggregator.

User Generated Reaction Method

By interacting with an advertisement, the mobile user will call their camera to open and are able to immediately capture a photo, video or audio instantly or can recall captured content via a gallery. This method is completely embedded within the mobile application, site or portal where the content was originally presented. A gallery, for the purposes here, utilizes aspects of current technology to access previously captured or recorded mobile content. Accessing of this content is done so through the embeddable application, although the accessed content itself was previously captured. For example, an advertisement that appears within an application or mobile website displays an embeddable interaction to ‘react’ to the advertisers content. The content a user is reacting to has been shared via the floating backend system and aggregator distributed to the platform the user is engaging with.

This is a self-sustaining process, that could potentially eliminate the need for advertising agencies or outlets that solely create mobile or web advertising content. This method illustrates a manner by which users create content and react to each other, creating a self-sustaining process that is fully embedded within each mobile application, framework, website or portal itself.

The combination of content created on a separate application or within an application can be connected, processed, and shared together, depending on the input parameters. Therefore, content that is created within the application using the ‘reaction’ method can be paired in combination with any content created in the ‘primer’ method. Together, the content may be shared in accordance with the parameters inputted in the aggregator by both the advertiser (e.g. brand or business) and the host (e.g. application developer or portal host). Additionally, users or brands may contribute and collaborate together. For example, a brand may capture an image and ask for a user to complete the image, thereby combining and sharing images together, although they were captured separately. The content, in this example, could then be adhered together and shared together as one component or multiple components, depending on the preference of the advertiser. This is an example of how a user may create content that contributes to an advertiser's campaign but may also may be used concurrently with content an advertiser creates, meaning content may not only be shared but may be adhered or combined together and then shared.

Embeddable Creation and Distribution

Content that is created by using either a primer or reaction method are fully embeddable within the application. This includes the creation of the content, sharing of the content, among other aspects outlined below. As a mobile application developer or site host embeds the aggregator via the code base within the application or site itself, the camera and gallery are accessed through the code base and aggregator utilizing the floating backend system. To further illustrate this method, the entire camera capture process, sharing mechanisms, shopping and payment processing, rewards or gamification system and or any other aspects associated with the advertisement process are fully embeddable within the mobile application, site, or portal. This creates a completely embedded experience as a mobile user does not have to leave an application or site to purchase or engage with content further. For example, a mobile user may see an advertisement within a mobile application. The user may purchase or shop for a product, e.g. running shoes, within the application itself, not forced to leave the application or site to access a new window, page or application as current processes demand. While interacting with a third party or advertiser's content, the user is doing so within the application or web site, not leaving to open multiple new pages or windows, resulting in a faster, more succinct shopping experience. This embeddable shopping and payment processing system is made possible through the backend floating system in combination with the aggregator. By using the uniques aggregator with the floating backend system, these advertising processes are fully embeddable within the application or site, resulting in a completely embeddable experience for the mobile user and the application or site host. With the method introduced here, mobile users stay completely within the application, able to interact, engage, and access all advertisement processes (accessing the camera, any capture processes, all sharing including on other social networks or messaging platforms, shopping or payment systems within the application, any rewards or gamification elements and any other aspects central to the advertising experience) that are fully within the mobile application or site itself. This results in a complete experience completely embeddable within the application as users do not have to leave the mobile application, site or portal where content is presented to them. Once completed with any interaction or purchase, as the user has remained within the original portal throughout their interaction, the user then returns to the original content they were engaged with, i.e an article, social feed, or mobile game, before the advertisement was presented. The entire interaction and completion of the advertisement was fully embeddable in the mobile application or site. Parallel campaigns are similarly embedded within the application or site, as one may see or view content on one application or portal as it is being shared on another. This process is fully embeddable and occurs within each relative application as the live, cross-platform sharing is occurring through the aggregator and code base. This instantaneous sharing across multiple platforms is made possible through the joint access of the aggregator and floating backend system.

Sharing of Content

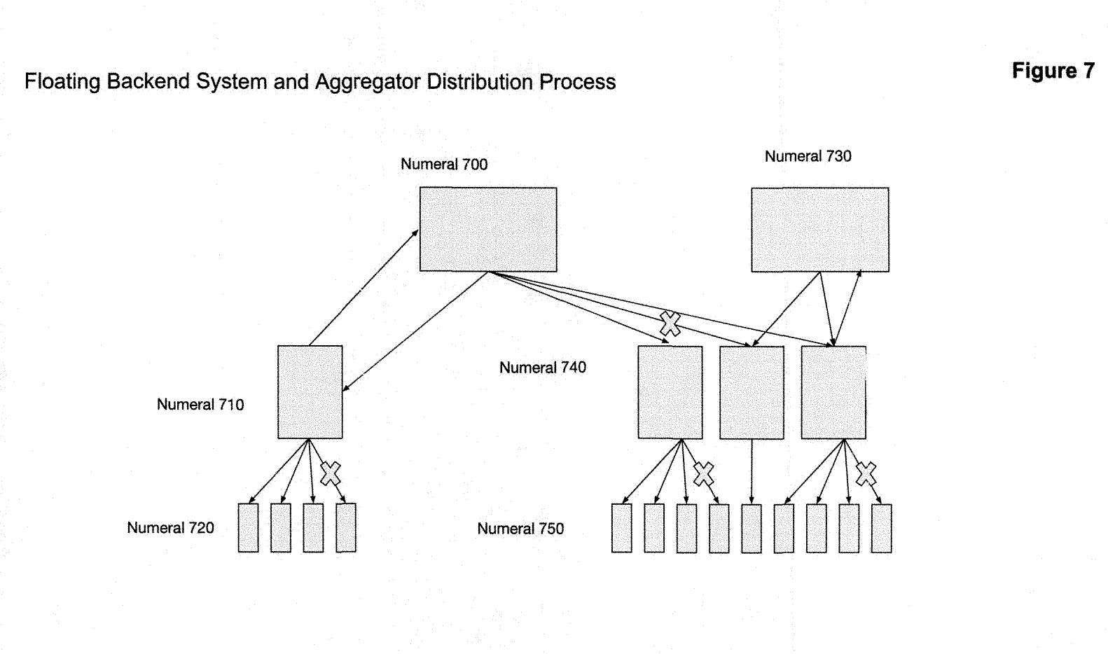

Additionally, sharing is made possible through the use of the floating backend system and the aggregator. Users have the ability to leverage social networks, messaging systems, and other platforms to share any content they create or engage with. For example, a user may want to share content they create within an embeddable application or site with other people on social networks, other platforms or even other mobile applications. The sharing system enables a user to share content that they generate or content that they interact with. This content created or consumed may be shared among the application or site as well as on other platforms or services, using the aggregator and floating backend system. Illustrated in FIG. 7, content created, submitted or interacted with on a mobile application or site may be shared via the use of the floating backend system, described in detail below. Any content created or engaged with that is interactive, an image, video, audio or other form of content may be shared using the floating backend system and aggregator to become consumed on the platform or service relative to where a user shares it. For example, if a user on application A reacts to an advertisement and either creates or shares previously captured content, the content, while originating from application A, is shared and fully interactive on application B or any other site or platform using the aggregator. Content originates from the portal where it is created and then shared via the floating backend system, where It is then distributed to appropriate aggregators (that are embedded via the code base on separate sites, portals or mobile applications) with matching terms or items to improve the end relevance to the mobile user. This process occurs concurrently and is able to simultaneously operate. The aggregator is able to recognize the importance of the keywords and other tagged items to more accurately distribute content. Moderation also offers a key component of sharing, illustrated more closely below.

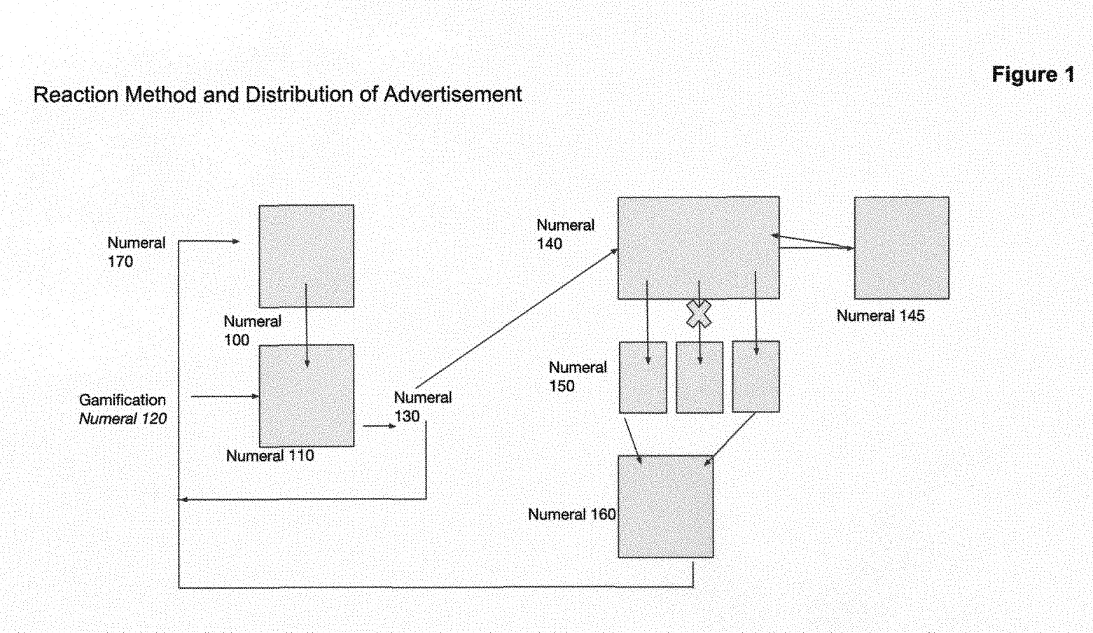

Content may be shared privately or publicly. Content created privately is content that is not shared for public consumption. Although created or interacted with on the application, site or portal, content may be created solely for the purpose of engaging with content, rather than both creating and sharing, as some individuals may not want content they create shared publicly. They may still interact if they choose, or to receive any sort or reward or incentive, or for any other reason. As illustrated in FIG. 1, a user that reacts to content, by either creating their own content live, adding content from a gallery that was previously captured, or that they may ‘favorite’, share or engage with may be done so publicly or privately, granted approval by the mobile user. This grants users a choice to share the content they create or interact with, among other platforms, sites or portals. Restrictions may also be placed on how wide the scope of sharing of the content is, as people may only wish to share based on certain parameters. These parameters could be, size, localization, specific tagging of sites or other factors. For example, a user may only wish to share content on one application or service and not others. Sharing on mobile sites or portals is not dependent on one another, as a user may privately create content and only share it with a friend using a messaging service, for example. In this case, a user still wishes to share content they created but to do so only with a friend and not through a more broad approach, as sharing publicly among other platforms would. By using parameters, users may declare where and who they would share content with. Adhering to these parameters inputted by the user is possible and achieved through tagging items in the aggregator.

If chose to share content, certain overlays or embodiments may be applied to the content, as this may be significantly important to advertisers or portal hosts. Descriptions of content, additional tagging of content, or more actions to overlay will additionally contribute to content that are made possible through the use of the aggregator. For example, a mobile user may capture and share an image of a new dress, but may incorrectly add a description of the price. An advertiser or brand, then, could alter the content to reflect the accurate price or information of the product, such as the item is on sale for a limited time. Approval may be necessary for this alteration of content from both parties, with approval mechanisms made possible through the moderation of content to be distributed. This helps to clarify and correct any content that may be inaccurate or that may give false pretenses about products, in addition to supplying more and/or corrected information of resources (such as links) that an advertiser may wish to provide a user viewing the advertisement. All of these changes or alterations are applied to the original content forming revised content that is shared across other sites, portals or platforms.

Live Camera Display

The reaction system also makes use of an embeddable camera within the relative application, site or portal to provide a live reaction to content. This includes the use of camera filters, that accompany an embeddable camera within a portal. For example, a company may display multiple filters around the holiday season for people to utilize when capturing content for a campaign. In this example, a user would be able to react to an advertiser's content by opening a live camera, that is fully embeddable within the application via the codebase, with multiple filters featuring snow moving or other filters associated with the holiday season, in this example. A user, in this case, would then have the option to open the embeddable camera to react to an advertisement or other form of content, as filters may appear to give a user a better, more engaging experience. These filters may be either static, such as a non-moving filter with a stationary overlay, or moving, such as a filter that has a moving snowflakes. These filters are both live and embeddable within the application or portal where the end user is interacting. The camera displays instantaneously through either an action of a user or a designated input by the portal host or advertiser. For example, a user may select an icon to pull the live camera, i.e. an action, or the camera may be displayed through a parameter that was input by the portal host or advertiser (e.g. delayed response, number of interactions of a user). The camera itself is live as it is embedded within the application. There is a distinction however, that while the camera may be embedded, content itself may be shared to other people on other mobile applications or portals or other platforms. Interaction with the live camera is occurring simultaneously as the user capturing content is doing so as the embeddable system is processing, thus creating a ‘floating’ system as the content being created is within the application and does not have another operating location.

Physical location may also be utilized to access certain or specific filters, or other graphical displays. Once a user is present at a location, the location Will trigger a filter to display or be recommended to display based on past user events or other behaviors or inputs of the active user (the person engaging with content) or other users (people on other platforms sharing or creating content). To share this content, a user may choose to do so privately or publicly, as publicly sharing content on other platforms creates an open network of other users on other platforms and portals to see that content, compared to privately sharing content that will be shared with the sole user (who generated the content) or to a specific network of selected users. Through the parallel input, content that is created on one portal is live on another, with moderation features necessary.

Feed, Organization and Display of Advertisements

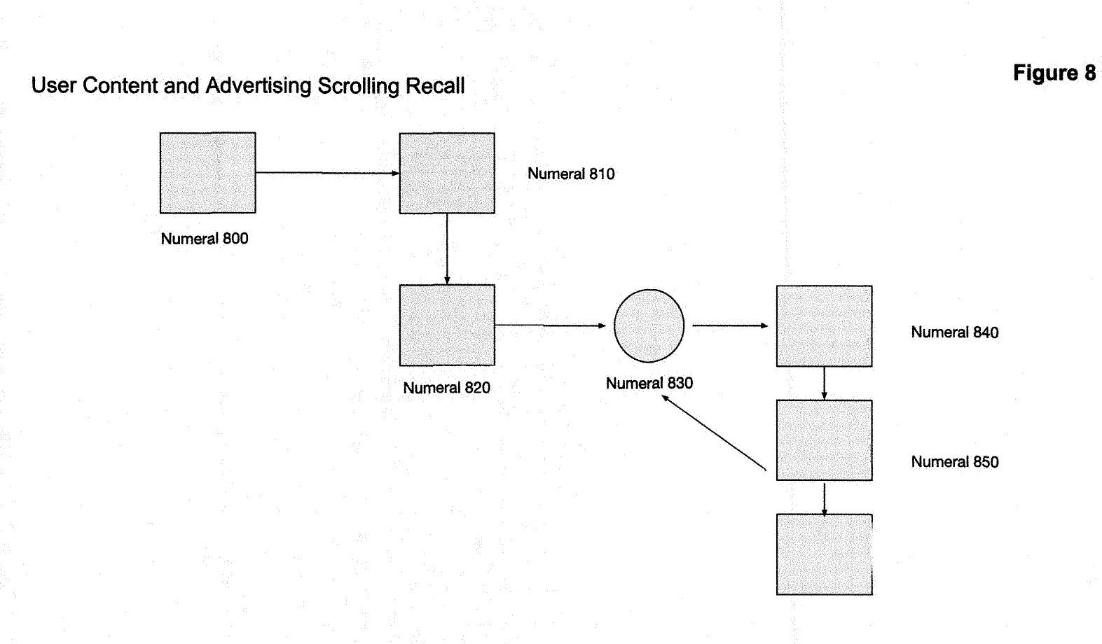

The advertisements themselves are displayed in an order designated by the aggregator and parameters inputted by the advertiser, application or portal host, or the end user. Once a user views an advertisement, they may move selectively to see additional content shared or may leave returning to the original application or site by which they were accessing. By moving to view additional content, a user may engage with the advertisement and open a ‘feed’ or collection of content displayed to a user. This feed of content is embedded within each mobile application respectively and is made possible through the floating backend system and aggregator. Multiple feeds may be identical or solely unique dependent on the aggregator parameters. Illustrated in FIG. 8, as a user engages with content, additional content may be called within the application, creating a feed or consequential presentation of content. For example, if a user is engaged with content, they may wish to see additional content that is presented to them. By moving a finger, for example, content is then instantly called by the engagement or interaction of a user and presented to them. A user may continue scrolling to see additional content (including replies, comments and other forms of new content) in addition to having the ability to review (i.e backwards) to see content already presented to them. Much like a feed on other platforms or sites, the end user has total control of the interaction of the content, but not necessarily the presentation of the content.

The format and organization of the content may be solely created within the application, by a separate user, by a specific advertiser, or by an individual on a separate third party platform or site. The makeup of such a feed, therefore is based on the parameters of the aggregator inputted by the content creator, site host, advertiser or end user. For example, a user may see content that is curator to meet their specific requests or certain elements designated by the site host. Liking or favoriting of content, among other engagement parameters, may influence the organization of the feed, and will do so instantaneously unless otherwise directed by the input parameters. Based on the inputted parameters within the aggregator, the feed organization will automatically update and adjust accordingly to new content submitted via the aggregator or based on engagement parameters (such as content receiving new favorites or ‘likes’).

An end user may have control over the content presented to them to improve relevancy or adhere to preference, as some user may be offended by objectionable content. This control over content and how it is presented to them, provides greater engagement and more authority over their experience. Additionally, site hosts or brands have access to the order and moderation of content depending on certain preferences, with the ability to organize content by factors such as time (i.e most recent), by location or by other factors that they ultimately desire. A site host or brand may wish to organize a content feed by other parameters such as which content is shared the most, what content is the ‘liked’ (i.e. favorited or loved by other users) the most or the least, what was most recently liked and other factors contributing to the overall organization of the feed as it is displayed to an end user. Content distributed from different aggregators via separate applications may merge together to form and organize content to be presented by a user through the parameters of the aggregators unique to each platform or portal. Other aggregators and backend systems may have separate integration to the same platforms or portals, as depicted in FIG. 7.

As this method includes a way to create an advertisement feed that is fully embeddable within the application, the presentation of the content includes a method as a user may see content, and continue to see additional content through scrolling or other interactions. This scroll method, illustrated in FIG. 8, shows additional embedded content called within the application or site by indication of the user. In this way, a user may see additional content through the system without leaving the original site or portal. The presentation of the advertisements themselves offer a way for advertisers to better tailor content to future users and for site hosts to adhere to preferences of users.

Floating Backend System

The floating backend system enables much of the behaviors of this method to occur. The term ‘floating’ is agile in the idea of where it being stored. The content that is created within an embeddable system of an application or site, is stored within a floating backend system that allows live transfer of content to other select applications, portals, or networks. Any combination of these elements together assist in supporting the backend storage and processing of content. While looking to contribute content, users may have already generated their content that is previously stored on a mobile device or other network service. Pulling content from these sources and sharing to the agile backend system allows users to access content relative to their own profile, to their own portal, and ultimately to their own network. The backend system, illustrated in FIG. 7 allows content to be created fully embedded within the relative platform or site, and to be shared selectively among other users on the same application itself or on other sites, applications, or third party platforms. This content shared via the floating backend system is fully embeddable and resides temporarily within the application or portal itself, making the content storage system unique to that location. By making it unique to the location, as illustrated in FIG. 7, content may be distributed solely to the application or portal itself or may be selectively distribute to other portals instantaneously, as explained in detail below. This allows users to react and contribute to one another on different locations or portals at a selectively instantaneous manner. Other aggregators may have simultaneous input into the same application or portal, allowing content to be distributed together from different input points (content creating locations) to the end user. For example, content created on Application A may be presented in addition to content created on Application B and ultimately presented together to a user on Application C.

The backend system is ‘floating’ in the sense that it is storing content originally created on one application or site, that responds directly with the aggregator associated with that original site or portal. Content that is uploaded or created from a site, application, or portal by a user is stored through the floating backend system that responds directly to the aggregator by which it was sent. This way a user may see content on an application or site privately (as only they may view it) with no other individual or party engaging or seeing that content. In this manner, the content Will be held by the floating backend system and serviced or then redistributed to the application itself through the aggregator. Based on the inputs of the aggregator, the content may be redistributed to other portals and/or to other users on the same application by which it was created or it may be distributed to other aggregators servicing other portals, applications or sites. By way of example, a user may generate content on Application F. The content they created, but did not share, is stored on the floating backend system, and is only viewable on Application F to the user who created it. Once selected to share, the content is then designated to be shared through other aggregators that service other platforms. In this way, no two aggregators have the same storage of the same content, resulting in a way that content created would have an original designation or portal by which it was shared. The significance of the floating backend system is it allows content to be created and stored on a signal application or site while being selectively distributed to other sites or portals and to the unique users of each of those sites, the advantage of this is allowing multiple people to access and contribute to the same piece or series of content.

The backend system is then ‘floating’ in sense to store content creator on one application or site, uploaded and shared to other aggregators based on the input of the designation of the original aggregator. Meaning content that is created on one application will be stored on that application, via the specific floating backend system. That content, while stored on the application or site it was created, may be shared to other applications or sites using that specific floating backend system which is then distributed to specific aggregators getting the sharing parameters, but will not be stored on those applications or sites to which the content was shared. Sharing parameters are fully adherent to the input parameters designated by each aggregator, assigned by portal hosts, advertisers and in some instances users. This allows for content to be created on different platforms, sent to the floating backend system and distributed to each unique aggregator. Essentially showing that every aggregator is unique to every application or portal, while the backend infrastructure ‘floats’ or moves in between each aggregator to provide, store, and distribute content.

Embeddable Shopping and Payment Processing

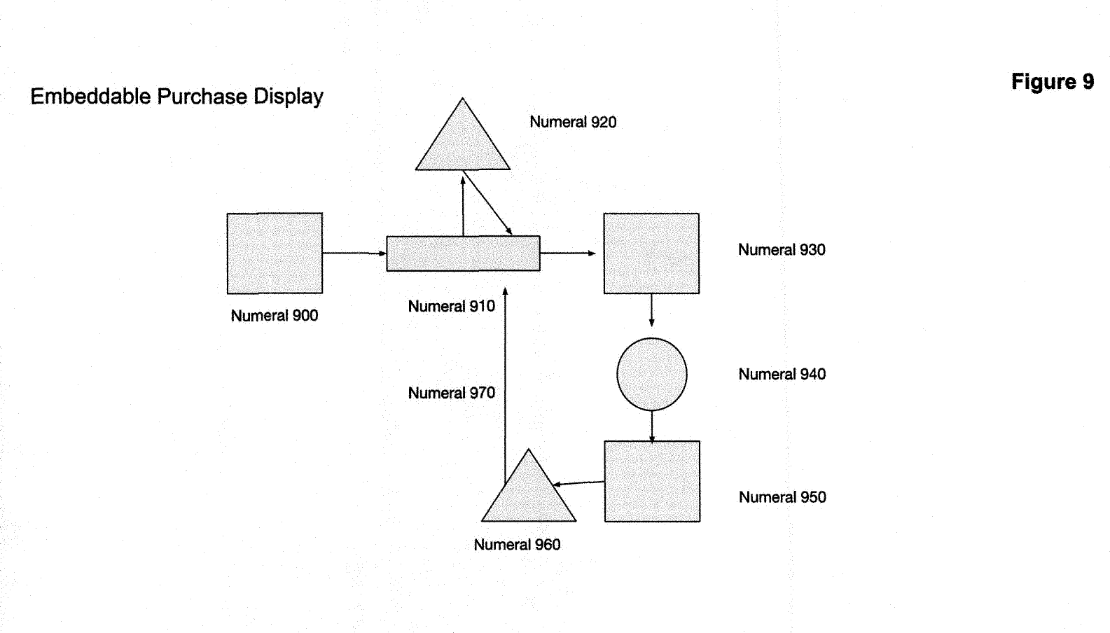

In an extension, the method includes a way to shop as an embeddable segment within the application. This method allows a mobile user to shop, checkout, store items for later and pay for items all while remaining within an application or site. The benefit this allows a user to purchase items more efficiently and effortlessly, while remaining within their original platform or site. Utilizing the backend system, an advertiser may include a payment method to purchase an item, product or service. The process of payment is fully embeddable within the application. The overlay of the checkout process occurs alongside the advertisement presented to a user. FIG. 9 demonstrates this, including a purchasing method and a ‘save’ method where a user may save a purchase for later. This is made possible if the user is able to authenticate and register, as described below in the ‘Profile Tracking’ section. Relating to content overlay, a brand or business may tag content generated by a user with a price and way to purchase or save an item for later. In this way, if a user wishes to purchase a product or service from content they are engaging with, they may do so entirely within the application or portal itself. If a user reacts or shares content additionally, the purchasing and payment processing system may accompany that content that is shared with other end users. This allows for content that is shared or created by either an end user or an advertiser to allow purchasing of the product or service the content showcases. Moderation tools may impact this at the discretion of the advertiser.

Embeddable Query and Communication

Within this method, exists a way to communicate via manual direct message or automated chat bat (or any combination of the two) from one application to a second, separate application. This method enables a user on one application or portal to remain fully within the portal, while messaging a separate user on a separate application or portal. Users may directly engage with one another or in a group, or separately engage with an entire community of public users who may see the content. Additional ‘comments’ or reaction of other users may be instantaneously shared among other platforms via the aggregator.

Additionally, an end user may message a brand or business who is posting advertising content. This direct messaging functionality is embeddable within the application or portal and grants a user the ability to communicate, share links or content with the brand individually. For example, if a user has a question regarding the store hours of a local cafe, it may message or engage with the store directly. The store may respond directly or may use the implementation of a programmed communication bot to respond to the content of the message from the user. These programmed communication bots may be set to provide a programmed response or sharing of content, designated by the original brand or business distributing the advertisement. In this example, to note the store hours, the bot respond with store hours or neighboring stores that remain open. This additional sharing of outbounding content, such as links or additional packets of information, may accompany the bot or the direct message and may remain fully embeddable within the application or site. This programming message and its functionality may be overlaid on content created and/or distributed by a user.

Parallel Campaigns

Advertisers may wish to run parallel campaigns on multiple different platforms simultaneously. Parallel campaigns enable content to be created on one application at the same time, as users may react and engage with each other. For example, embedded within two separate applications users may be able to see one another over a live camera feed and communicate with each other, using different filters and other forms of content entertainment. Parallel campaigns allow people to see the same content on multiple different platforms at the same time, instantaneously. This method of parallel campaigns allows for the instantaneous creation, contribution, or alteration of content on different platforms live instantaneously. With this method, by way of example, content may be altered on one application by one user while being viewed live on another application.

Gamification and Rewards of Content Creation

Gamification is an equally important aspect of this method. Users may earn rewards for creating or engaging with content. Gamification or a reward system may be based on parameters designated by the aggregator, which may be inputted by portal hosts, advertisers and in some cases users. Users may be rewarded for creating and contributing to content. For example, a user may be rewarded for creating content supporting a shoe campaign. The advertiser of the shoe campaign, in this example, may provide a 15% discount on their next purchase of a pair of shoes. Certain percentages or other analytics may be utilized to trigger rewards or incentives. This means that the behavior of a user may tracked to enable them to earn a certain set of rewards or discounts. A point system or other reward mechanism may also be used to continue to engage and earn users rewards. Additionally, a ‘gamification’ or creative way to make the advertisement creation and contribution method a ‘game’ for users, or a form of fun entertainment for users, may utilized to incentivize people to create or contribute to content. Additionally a user may create content for multiple campaigns that are different and separate from one another yet still earn rewards from both that may be applied for the same prize. By way of example, if a user generates content for one campaign they may create content for another yet earn ‘points’ for both, perhaps 5 points for the first campaign and 20 for the next. Combining the two, in this example, would would create 25 points to use on an item. The point system or rewards may be tracked from user to user or within groups, such in a universal reward platform. Additionally, content appearing on third party applications or sites may still contribute a reward to users using the backend system. Users may need to login to engage with content and may do so using a profile account they may set that is fully embeddable within the application, or may choose other authentication methods including third party platforms, thumbprints or other unique login and authentication protocols outside of traditional profile accounts.

Content Moderation

Moderation is an extremely important aspect of this process. As content is created and submitted to the aggregator, content may be moderated via a dashboard. Content is sent through the dashboard via the aggregator to give portal hosts or advertisers access to moderation tools. Content may be inappropriate or unnecessary and violate specific guidelines outlined by a brand or advertiser or even guidelines of the portal host. Content may be shared to select audiences, such as those with end users who have opted in to potentially objectionable content. Otherwise deemed objectionable by the portal host or advertiser, may be stopped from sharing and removed from distribution channels at any time. Content may also be moderated in what is shared for specific end users.

The moderation of content occurs at the aggregator, where content is submitted and not yet shared. Before content is shared publicly, the moderation tools provided to the advertiser or site host may be enabled to ensure content meets standards or specifications that the advertiser, site hosts or end user may process. As a result, each aggregator controls the moderation of content, as content presented is relative to the moderation parameters on each site, portal, or application. This enables a method where content may be appropriate on one application but not another. In this way, for example, content that may be seen as mature on an application may not be appropriate for children on a children's application. Moderation, additionally, may be altered to reflect more accurate information or additional details that may be important to the end user. For example, knowing the accurate start time and date of a certain event would be beneficial to the end user. In this way, users may add content or details to each others content. The moderation of this may happen instantaneously, as becomes apparent through inputted parameters on the aggregator.

Direct Content Overlay and Tagging

Overlay of text or other images is a natural want or need of an advertiser. As a form of extension of moderation, users or brands may add additional detail or messaging overlay to content. While not creating the content originally, content may be altered by other users to add greater detail or entertainment value to the product. Final moderation of the content may be approved or validated by the brand or advertiser and site host through the use of the aggregator. Adding additional features that provide entertainment value, such as a new filter for a photograph or video, may provide additional value. Other changes to content may be improving the accuracy of the information provided. By way of example, if a user creating content may have inaccurate information, such as an incorrect price of an item or an inaccurate location, content may be altered. This content may be altered or added to at any point in the cycle of its sharing by either a user, portal host or brand to add additional value. By adding additional information, a brand, portal or user, may tag content with links to other platforms or services both within the aggregator and through third parties. For example, an advertiser may tag a user generated image of a shoe they sell with a price on it. In this example, a user who engages with the content may select a link tagged within the photograph to purchase the item. This method is illustrated in FIG. 9. As a brand or business tags an item in content, a separate user engaging with the content may purchase the item. Additionally tagging of locations, prices, and additional links may all be overlaid and tagged on content generated by users. These actions would then link users to the appropriate link either embedded within the aggregator itself or outbounded to a third party. Appropriate moderation tools offer significant value in this situation, as an advertiser or portal host has ultimate decision on specific forms of content, and the implementation or effectiveness of the input parameters of the aggregator.

Localized and Promoted Content

As localization is an important factor in advertising, utilizing mobile devices and the unique ability of devices to accurately track and target locations may be used in the method described herein. Localized content created by users may be distributed in a similar manner as described throughout. Once a mobile user's location is known certain rewards or gamification elements are made available or presented once the location of a user is recognized and matched with a reference point in an aggregator with parameters that are registered to that location. For example, once physically at a certain ice cream shop, a specific filter may open either on the device itself or on an application or site, based on user discretion and engagement. Using the aggregator associated with the application or site, the filter would appear as it is cross referenced with the known location of the user by using the floating backend system that would recognize the location of the user. In this way, content is made public only when centralized to that location. Additionally, content may appear on other third party platforms or sites while a user may be engaging with content. Promoted content may appear live at a location, requesting users to engage with content instantly. Using the floating backend system users within a certain physical location may have a filter, a reward, or other promotional entertainment tool presented to them using independent aggregators associated with their mobile device. For example, at a movie theater, an advertiser may ask a user to open a specific application, access a site, or redeem an item using an aggregator. Once connected, a certain filter may appear only at that desired location at that specific time, as enabled through the parameters of that specific aggregator. In this example, if Application A has a designated time and place where a video filter may appear, those parameters are assigned through the aggregator of Application A. Once a user opens Application A at the location and at that time (or time range), the video filter will appear. Other users who open Application A and are not at that location or that time do not receive that filter. In this way, filters may be ephemeral and only relevant to previously designated locations via the internal parameters on the aggregator.

Interaction with Other Mediums

Additionally, mobile users may wish to share content on other platforms or systems, and may do so while retaining content. Tying in social media and other platforms is an important element. Users may share content on other platforms, including social media or third party platforms, as described above. Sharing content from one application to another, utilizes the sharing element of the floating backend system. As a user may share content across multiple channels or platforms the content is called from the backend system and individual aggregator by which content was created or shared. An overlay of interaction on adjoining social media platforms is also fully enabled, giving individuals a range of interaction and engagement options. By plugging in the connection, the floating backend system will recognize and identify content a user wishes to share, while simultaneously accessing the end sharing location such as a separate third party platform, like social media. In this manner, seeing a cross linked platform that matches the input of an individual user, may lead to greater access to content creation, rewards, and other interaction methods. Content created on other platforms may also be shared within other applications or portals using the aggregator and floating backend distribution process. Other rewards or incentives are still able to be utilized with this method.

Discrete Profile Tracking and Login Authentication Method

Using the floating backend system, a user may be tracked leaving a specific trail. The benefit of such a profile system allows a user to avoid logging in on every selected device, portal or site. Instead a user may simply use other forms of authentication, such as their thumb print, a unique user identification numbers or password, username, third party authentication and other methods now known or later created. This system utilizes the floating backend system as it recognizes user logins on multiple aggregators across different time and access points, allowing greater user access to content creation, rewards or other benefits. Note, however, this does not impact specific logging in on the actual application, platform or service a user is accessing. Instead, rather, the discrete login and authentication method tracks a user's identity through the aggregator. In this way, a user may only be tracked on

What is claimed:

1. A method of user created advertisements comprising:
a computer server, storage, and backend system, that is agile in both the nature and storage of its components and content;
an embeddable computer component that is integrated within a codebase, either manually or automatically via a wrapper; and
a localized aggregator that is responsive to direct input parameters and fully communicative with a universal tracking and backend system.

2. The method of claim 1, wherein a floating backend system, utilizes a remote storage point, that flexibly and dynamically reads multiple inputs simultaneously to then accurately recall stored information relaying it to and from a local aggregator based on the unique parameters of that aggregator further comprising;
a communication endpoint between all responding aggregators that are read and analyzed by the floating backend system to instantaneously identify, sort, and act upon the proper sharing of information from the backend storage system relaying to the aggregator;
a directly responsive backend system that can access, analyze and interpret instances or parameter inputs of each localized aggregator; and
a cross platform sharing mechanism that enables the backend system to process multiple inputs across multiple platform variations and content requests simultaneously.

3. The method of claim 2, wherein a localized aggregator communicates directly with the backend system to effectively distribute content to and from its native platform further comprising;
a determination point processing the input parameters of the implementation host and end user creating the advertising content;
the identification of allowing or disallowing public sharing of the content created;
the adaptability to edit or alter content that may be misleading, inaccurate, or inappropriate; and
the final communication relay of parameters to the backend system.

4. The method of claim 1, wherein an embeddable purchase system overlays directly upon the advertisement, that, through standardized authentication, relays with identification numbers and tracking via the floating backend system, access payment information histories, that enables a properly identified end user to purchase a product or service directly within the advertisement on a platform.

5. The method of claim 1, wherein a single advertising campaign may be run simultaneously across multiple platforms or mediums, instantaneously responsive via the shared floating backend system to the parameters of the localized aggregator.

6. The method of claim 1, wherein an aggregator directly embedded within a native codebase, either manually or automatically, is organizable and directly responsive to the unique parameters of the local aggregator designated by the implementation host that further comprises elements:
identifying an end user via a remote identification component through standard authentication protocols;
accessing the content created on the platform at the local aggregator of that platform; and
allowing or disallowing unique identifiers, such as general tagging, filters, geolocation tagging, pricing, location, links, commenting, and other editable forms on the advertisement content at the local aggregator, before the release of the content from that local aggregator to the floating backend system.

7. The method of claim 6, wherein further comprising gamification and self-tagging direct overlay moderation components that are fully responsive to inputs by the end user creating an advertisement or engaging with one shared with them that further elements comprise:
a fully interactive geolocation element where responsive filters are editable by end users who are engaging with advertising content of other end users; and
a embeddable communication and instant messaging element that enables end users to connect directly via text messages, images and video with the advertisement design layout across platforms instantaneously.

8. The method of claim 4, wherein an accessible identification route, through standardized authentication, enables a reward based platform to track to a specific end user that may be used as a form, or partial form, of currency to purchase goods or services within the advertisement itself; and
utilizes tracking and data components to further incentivize and reward end users for the creation or interaction with end user advertisements.

9. The method of claim 1, wherein a fully embeddable advertisement response or react component enables a end user to create content directly with the advertisement itself; and
directly contributes this content to the local aggregator which identifies, sorts, and acts upon its parameter inputs, before sharing with the backend system.

10. The method of claim 1, wherein upon the call of an advertisement, a transverse bar may accessed via authentication protocols that enables specific users to selectively avoid seeing advertisements based upon the inputs of the aggregator and engagement performance of that specific end user.

11. The method of claim 1, wherein the components operate for mobile device technology.
